(19) United States
(12) Patent Application Publication
(10) Pub. No.: US 2007/0195808 A1
(43) Pub. Date: Aug. 23, 2007

(54) WIRELESS VEHICLE MESH NETWORK

(75) Inventors: Rodney P. Ehrlich, Monticello, IN (US); Paul D. Nelson, Martinsville, IN (US); Victor Vargas, Lafayette, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: Wabash National, L.P., Lafayette, IN (US)

(21) Appl. No.: 11/558,569

(22) Filed: Nov. 10, 2006

Related U.S. Application Data
(60) Provisional application No. 60/774,754, filed on Feb. 17, 2006.

(51) Int. Cl. H04L 12/56; H04J 3/16

(52) U.S. Cl. 370/408; 370/469

(57) ABSTRACT

A wireless multi-node communication network which includes a coordinator, and a plurality of vehicle nodes which are configured to communicate information back and forth with said coordinator. The system may include a plurality of clusters, each of which comprises a plurality of devices such as sensors. One of the devices of each cluster is configured to receive information from the other devices in the cluster, and transmit information to the coordinator. The coordinator not only receives information about the network, but may also be configured to route the information to other networks. The network could be disposed on a tractor-trailer, wherein the devices comprise different sensors, such as pressure sensors, temperature sensors, voltage sensors and switch controls, all of which are located in areas relatively close to each other.

### RELATED APPLICATIONS (PRIORITY CLAIM)

The present application claims the benefit of United States Provisional Application Ser. No. 60/774,754, filed Feb. 17, 2006, which is hereby incorporated herein by reference in its entirety.

### BACKGROUND

The present invention generally relates to systems and methods of communication between a trailer and tractor, and more specifically relates to a wireless vehicle mesh network.

For years, tractors in the tractor/trailer industry have been effectively a stand-alone system, having an integrated electronic control system. Currently in the industry, there is a wired connection between the tractor and trailer. Specifically, while the J1708 communication protocol has been in place for years, J1708 is being phased out in favor of a more advanced protocol, namely J1939. Regardless, the wired connection that has been in place between tractors and trailers in the industry provides that the tractor provides electrical power to the trailer, as well as operates the tail lights, turn signals, stop lights, and the brake system of the trailer. While the wired connection provides that the trailer communicates anti-lock brake system (ABS) lamp status information using a power line carrier implementation, the wired connection is not configured to provide any detailed information about the status of other aspects of the trailer. For example, the wired connection does not provide detailed information, from the trailer to the tractor, regarding tire pressure, air tank leakage, brake stroke, brake wear, refrigeration status, etc.

Information such as this would be useful because downtime is not only a tractor-related issue, as trailers also sometimes have downtime. For example, failing to monitor tire pressure often leads to tire failure, resulting in downtime. By being aware of trailer-related information such as tire pressure, downtime can be reduced.

Typically, sensors associated with a tractor-trailer are installed on a feature-by-feature basis, where each sensor is configured to sense a certain characteristic and is hard-wired to a display or controller (i.e., a “receiver”). The functions which are performed by the sensors are effectively isolated from each other, and there is no sharing of information between the sensors. Due to having to be hard-wired, providing sensing features has been costly in connection with tractor-trailers, and installation of the sensors has been difficult. Specifically, if a sensor is to be installed at the back end of a trailer, installation involves not only mounting the sensor, but also running one or more wires from the back end of the trailer to the front, and this often adds hundreds of dollars to the overall cost of the sensor.

While some networks on tractor-trailers have been wireless, such as the wireless tire pressure monitor system described in U.S. Pat. No. 6,705,152, these networks have involved only one-way communication—from the sensor to the receiver. These wireless networks have been configured such that the sensors almost continually transmit the information to the receiver, mainly because the sensor has no way to determine whether the information has been actually received by the receiver. This requirement of having to almost continually transmit information to the receiver has resulted in sensors which are utilized in wireless networks on trailer-tractors having a very short life. The wireless sensor networks which have been utilized in connection with tractor-trailers do not provide a power-efficient and cost-efficient means of implementing the management of sensors on the tractor-trailer.

### OBJECTS AND SUMMARY

An object of an embodiment of the present invention is to provide an improved method and system for tractor/trailer communication.

Another object of an embodiment of the present invention is to provide a method and system for tractor/trailer communication, where detailed information about different aspects of the trailer is wirelessly communicated to the tractor.

Still another object of an embodiment of the present invention is to provide a wireless sensor network which provides that the sensors effectively communicate with each other in the network.

Yet another object of an embodiment of the present invention is to provide a wireless sensor network which provides that the sensors do not have to continually transmit information to a receiver, thereby prolonging the life of the sensors.

Yet another object of an embodiment of the present invention is to provide a wireless sensor network which provides that the sensors, and the overall network, can effectively self-organize, without the need for human administration.

Briefly, an embodiment of the present invention provides a system of wireless communication between a trailer and tractor. The system is a wireless multi-node communication network which includes a coordinator, a plurality of vehicle nodes which are configured to communicate information back and forth with said coordinator, and a plurality of clusters, wherein each cluster comprises a plurality of devices such as sensors. One of the devices of each cluster is configured to receive information from the other devices in the cluster, and transmit information to the coordinator. The coordinator not only receives information about the network, but may also be configured to route the information to other networks. The network could be disposed on a tractor-trailer, wherein the devices comprise different sensors, such as pressure sensors, temperature sensors, voltage sensors and switch controls, all of which are located in areas relatively close to each other.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 illustrates the different layers of a vehicle network which is in accordance with an embodiment of the present invention;

FIG. 2 illustrates a mesh network architecture which is in accordance with an embodiment of the present invention;

FIG. 3 illustrates beacon network communication;

FIG. 4 illustrates non-beacon network communication;

FIG. 5 illustrates an example of the mesh network architecture of FIG. 2, implemented on a tractor-trailer;

FIG. 6 illustrates some possible sensors, etc. that may be implemented within the network;

FIG. 7 illustrates protocol stack features;

FIG. 8 illustrates the data frame format;

FIG. 9 illustrates the acknowledgment frame format;

FIG. 10 illustrates the MAC command frame format;

FIG. 11 illustrates the beacon frame format;

FIG. 12 illustrates CAN message content;

FIG. 13 illustrates a possible interaction sequence;

FIG. 14 provides a schematic view of the network, illustrating its reliability;

FIG. 15 illustrates the direct sequence aspect of the communication;

FIG. 16 illustrates a mesh network which is in accordance with an embodiment of the present invention;

FIG. 17 illustrates an exemplary block diagram for a sensor application;

FIG. 18 is similar to FIG. 17, but illustrates an implementation using a J1939 interface;

FIG. 19 illustrates three different topology models which can be used in association with the present invention;

FIG. 20 illustrates the joining of one network with another; and

FIG. 21 illustrates a trailer tracking model, which is in accordance with an embodiment of the present invention.

### DESCRIPTION

While the present invention may be susceptible to embodiment in different forms, there are shown in the drawings, and herein will be described in detail, embodiments thereof with the understanding that the present description is to be considered an exemplification of the principles of the invention and is not intended to limit the invention to that as illustrated and described herein.

An embodiment of the present invention provides a system where a trailer communicates status information to a tractor. Such information is preferably obtained via a plurality of sensors which are mounted in various places on the trailer. Such sensors may include, for example, air pressure sensors, brake sensors, cargo sensors, tire sensors (i.e., temperature and inflation), suspension sensors, refrigeration sensors, etc. Preferably, the sensors communicate information wirelessly to a router, and the router communicates the information to either another router or a coordinator.

Preferably, the wireless communication is performed via a proprietary protocol which provides low cost, is very secure and reliable, can handle up to 65,000 nodes, can be mesh networked, has power control, consumes very little power, can easily handle the J1939 structure, is very adaptable to sensors, provides that new members can be added quickly and is not proprietary, i.e., is an open architecture. Nevertheless, the wireless communication can be implemented via a different protocol such as ZigBee, cellular, Blue Tooth or WiFi, for example. Regardless of which protocol is implemented, the fact that the communication is wireless provides that there are no connector issues, that the system can be easily updated and expanded, and that the communication speed is fast.

Preferably, IEEE 802.15.4 packet data protocol is implemented because channel access is via carrier sense multiple access (CSMA) with collision avoidance and optional time slotting. Also, such protocol provides for message acknowledgment and renders beacon use possible. Additionally, multiple level security is possible and three different bands can be used: 2.4 GHz (16 channels, 250 kbps); 868.3 MHz (1 channel, 20 kbps) and 902-928 MHz (10 channels, 40 kbps). Preferably, the communication is along the 2.4 GHz band. Regardless, the IEEE 802.15.4 packet data protocol provides for a long battery life, selectable latency for controllers, sensors, remote monitoring and portable electronics. Still further, the IEEE 802.15.4 packet data protocol is advantageous in that it supports multiple network topologies including star, cluster tree and mesh.

An embodiment of the present invention provides a tractor-trailer wireless mesh sensor network architecture that effectively enables a power-efficient and cost-efficient means of remotely managing a plurality of sensors. The mesh network architecture provides that the sensors, and the overall network, can effectively self-organize, without the need for human administration. The present invention effectively makes a whole new class of wireless machine-to-machine or man-to-machine applications possible.

To date, most sensor networking architecture discussions have revolved around topology, but the present invention provides a mesh network which is effectively a data model, thereby providing a deeper and more development-focused wireless sensor network. Where topology refers to the configuration of the hardware components, a data model describes the way in which the data flows through the network. While topology is all about the network, a data model is a function of the application and describes the flow of the data driven by how that data is used. The present invention may be configured to communicate in accordance with two broad data model categories. One is data collection whereby in monitoring applications, data flows primarily from a sensor node to a gateway. Three common data collection models which can be implemented with regard to the present invention include: periodic sampling, event-driven, and store-and-forward. Secondly, bi-directional dialogue supports the need for two-way communication between the sensor/actuator nodes and the gateway/application. In this case, two different data collection models which may be utilized in connection with the present invention are polling and on-demand.

The present vehicle network is a wireless sensor network which is designed to replace the proliferation of individual remote application specific sensor systems. The vehicle network satisfies the market's need for a cost-effective, interoperable based wireless network that supports low data rates, low power consumption, security, and reliability. The present network eliminates the need to use physical data buses like J1939 and cables or wires to directly connect sensors to a controller.

Though the tractor/trailer vehicle network described herein covers only about 300 m, the network includes several layers, thereby enabling intrapersonal communication within the network, connection to a network of higher level and ultimately an uplink to the fleet, tools, or to the driver of the vehicle. These layers facilitate the features that make vehicle network very attractive: low cost, easy implementation, reliable data transfer, short-range operations, very low power consumption and adequate security features.

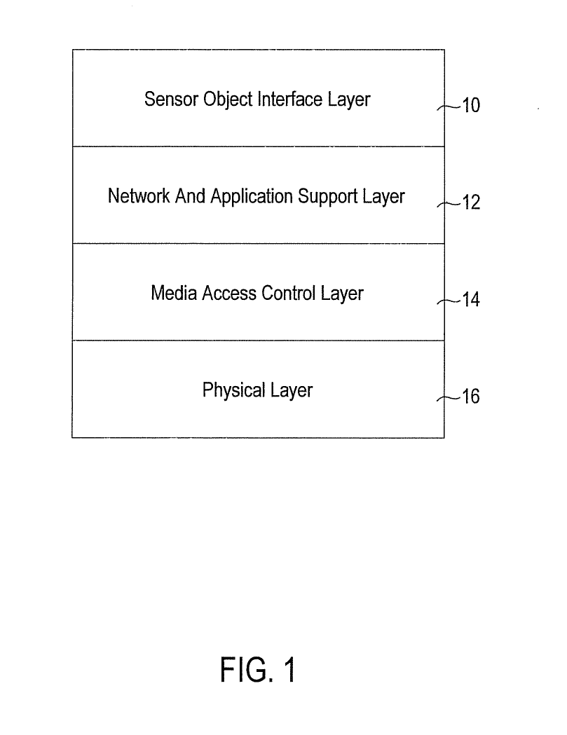

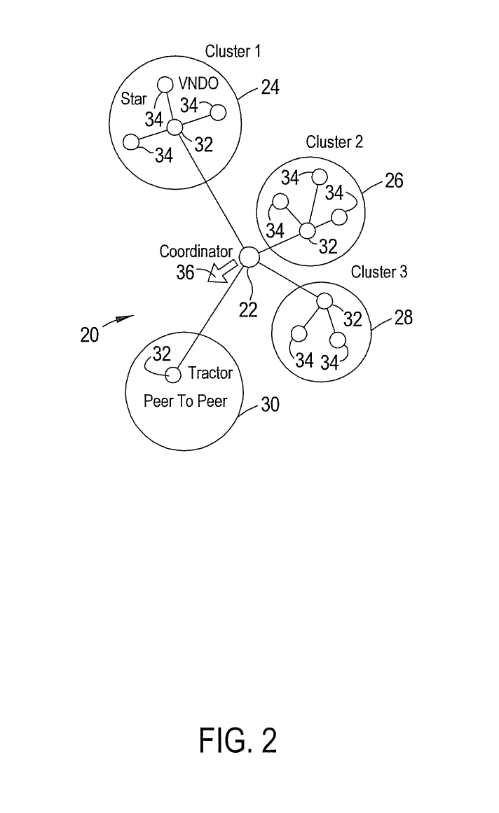

As shown in FIG. 1, the layers include a Sensor Object Interface Layer 10, a Network and Application Support Layer (NWK) 12, a Media Access Control (MAC) Layer 14, and a Physical Layer 16. The NWK layer 12 is configured to permit growth of the network without having to use high power transmitters, and is configured to handle a huge number of nodes. The NWK layer 12 provides the routing and multi-hop capability required to turn MAC level 14 communications into a mesh network. For end devices, this amounts to little more than joining and leaving the network. Routers also have to be able to forward messages, discover neighboring devices and build up a map of the routes to other nodes. In the coordinator (identified with reference numeral 22 in FIG. 2), the NWK layer can start a new network and assign network addresses to new devices when they join the network for the first time. This level in the vehicle network architecture includes the Vehicle Network Device Object (VNDO) (identified in FIG. 2), user-defined application profile(s) and the Application Support (APS) sub-layer, wherein the APS sub-layer's responsibilities include maintenance of tables that enable matching between two devices and communication among them, and also discovery, the aspect that identifies other devices that operate in the operating space of any device.

The responsibility of determining the nature of the device (Coordinator or Full Function Sensor) in the network, commencing and replying to binding requests and ensuring a secure relationship between devices rests with the VNDO. The VNDO is responsible for overall device management, and security keys and policies. One may make calls to the VNDO in order to discover other devices on the network and the services they offer, to manage binding and to specify security and network settings. The user-defined application refers to the end device that conforms architecture (i.e., an application is the software at an end point which achieves what the device is designed to do).

The Physical Layer 16 shown in FIG. 1 is configured to accommodate high levels of integration by using direct sequences to permit simplicity in the analog circuitry and enable cheaper implementations. The physical Layer 16 may be off the shelf hardware such as the Maxstream XBEE module, with appropriate software being used to control the hardware and perform all the tasks of the network as described below.

The Media Access Control (MAC) Layer 14 is configured to permit the use of several topologies without introducing complexity and is meant to work with a large member of devices. The MAC layer 14 provides reliable communications between a node and its immediate neighbors. One of its main tasks, particularly on a shared channel, is to listen for when the channel is clear before transmitting. This is known as Carrier Sense Multiple Access—Collision Avoidance communication, or CSMA-CA. In addition, the MAC layer 14 can be configured to provide beacons and synchronization to improve communications efficiency. The MAC layer 14 also manages packing data into frames prior to transmission, and then unpacking received packets and checking them for errors.

There are three different vehicle network device types that operate on these layers, each of which has an addresses (preferably there is provided an option to enable shorter addresses in order to reduce packet size), and is configured to work in either of two addressing modes—star or peer-to-peer.

FIG. 1 designates the layers associated with the network, meaning the physical (hardware) and interface to the MAC that controls the actual performance of the network. FIG. 1 is a description of one “node” while FIG. 2 shows the topology of individual “nodes” and how they are tied together to form the network.

FIG. 2 illustrates a mesh network architecture which is in accordance with an embodiment of the present invention. As shown, the network 20 includes a coordinator 22, and a plurality of clusters 24, 26, 28, 30. Each cluster includes several devices 32, 34 such as sensors, each of which is assigned a unique address. One of the devices (identified with reference numeral 32) of each cluster is configured to receive information from the other devices in the cluster (identified with reference numeral 34), and transmit information to the coordinator 22. The coordinator 22 not only receives information about the network, but is configured to route the information to other networks (as represented by arrow 36 in FIG. 2). As will be described in more detail hereinbelow, the network 20 could be disposed on a tractor-trailer, wherein the devices 32, 34 comprise different sensors, such as pressure sensors, temperature sensors, voltage sensors and switch controls, all of which are located in areas relatively close to each other.

The mesh network architecture provides that the sensors, and the overall network, can effectively self-organize, without the need for human administration. Specifically, the Vehicle Network Device Object (VNDO) (identified in FIG. 2) is originally not associated with any network. At this time it will look for a network with which to join or associate. The coordinator 22 “hears” the request coming from the non-associated VNDO and, if the request is pertinent to its network, will go through the process of binding the VNDO to the network group. Once this association happens, the VNDO learns about all the other VNDO's in the associated network so it can directly talk to them and route information through them. In the same process, the VNDO can disassociate itself from the network as in the case of a tractor (VNDO) leaving the trailer (Coordinator) and then associating itself to a new trailer. The VNDO is an embodiment of both hardware and software to effect the performance of the network. This includes how each element interacts with each other, messages passed, security within the network, etc.

As shown in FIG. 2, there is one, and only one, coordinator (identified with reference numeral 22) in each network to act as the router to other networks, and can be likened to the root of a (network) tree. It is configured to store information about the network. Each cluster includes a full function sensor (FFS) (identified with reference numeral 32) which is configured to function as an intermediary router, transmitting data to the coordinator 22 which it receives from other devices (identified with reference numeral 34). Preferably, each FFS is configured to operate in all topologies and is configured to effectively act as a coordinator for that particular cluster.

The architecture shown in FIG. 2 is configured to provide low power consumption, with battery life ranging from a month to many years. In the vehicle network, longer battery life is achievable by only being used when a requested operation takes place. The architecture also provides high throughput and low latency for low duty-cycle applications, channel access using Carrier Sense Multiple Access with Collision Avoidance (CSMA-CA), addressing space for over 65,000 address devices, a typical range of 100 m, a fully reliable “hand-shaked” data transfer protocol, and different topologies as illustrated in FIG. 2, i.e., star, peer-to-peer, mesh.

The mesh network architecture shown in FIG. 2 has the ability to be able to enhance power saving, thus extending the life of the module based on battery capacity. The architecture is configured to route the information through nodes 32, 34 in the network and also has the ability to reduce the power needed to transmit information. Specifically, natural battery life extension exists as a result of passing information through nodes that are in close proximity to each other.

The sensors 32, 34 in the network are configured such that they are able to go into sleep mode—a mode of operation that draws an extremely low amount of battery current. Each sensor 32, 34 may be configured such that it periodically wakes, performs its intended task and if the situation is normal, returns to its sleep mode. This manner of operation greatly extends the life of the unit by not continually transmitting information, which in a typical vehicle network is the greatest drain on the battery capacity. While in sleep mode, the gateway device 32 requests information from the other devices 34 in the cluster. Acting on this request, the devices 34 wake up, perform the intended task, send the requested information to the gateway device 32, and return to sleep mode.

The vehicle network may be configured to addresses three different data traffic protocols:

1. Data is periodic. The application dictates the rate, and the sensor activates, checks for data and deactivates. The periodic sampling data model is characterized by the acquisition of sensor data from a number of remote sensor nodes and the forwarding of this data to the gateway on a periodic basis. The sampling period depends mainly on how fast the condition or process varies and what intrinsic characteristics need to be captured. This data model is appropriate for applications where certain conditions or processes need to be monitored constantly. There are a couple of important design considerations associated with the periodic sampling data model. Sometimes the dynamics of the monitored condition or process can slow down or speed up; if the sensor node can adapt its sampling rates to the changing dynamics of the condition or process, over-sampling can be minimized and power efficiency of the overall network system can be further improved. Another critical design issue is the phase relation among multiple sensor nodes. If two sensor nodes operate with identical or similar sampling rates, collisions between packets from the two nodes are likely to happen repeatedly. It is essential for sensor nodes to be able to detect this repeated collision and introduce a phase shift between the two transmission sequences in order to avoid further collisions.
2. Data is intermittent (event driven). The application, or other stimulus, determines the rate, as in the case of door sensors. The device needs to connect to the network only when communication is necessitated. This type of data communication enables optimum saving on energy. The event-driven data model sends the sensor data to the gateway based on the happening of a specific event or condition. To support event-driven operations with adequate power efficiency and speed of response, the sensor node must be designed such that its power consumption is minimal in the absence of any triggering event, and the wake-up time is relatively short when the specific event or condition occurs. Many applications require a combination of event-driven data collection and periodic sampling.
3. Data is repetitive (store and forward), and the rate is fixed a priori. Depending on allotted time slots, devices operate for fixed durations. With the store-and-forward data model, the sensor node collects data samples and stores that information locally on the node until the transmission of all captured data is initiated. One example of a store-and-forward application is where the temperature in a freight container is periodically captured and stored; when the shipment is received, the temperature readings from the trip are downloaded and viewed to ensure that the temperature and humidity stayed within the desired range. Instead of immediately transmitting every data unit as it is acquired, aggregating and processing data by remote sensor nodes can potentially improve overall network performance in both power consumption and bandwidth efficiency.

Two different bi-directional data communication models which may be utilized in connection with the present invention are polling and on-demand.

With the polling data model, a request for data is sent from the coordinator via the gateway to the sensor nodes which, in turn, send the data back to the coordinator. Polling requires an initial device discovery process that associates a device address with each physical device in the network. The controller (i.e., coordinator) then polls each wireless device on the network successively, typically by sending a serial query message and retrying as needed to ensure a valid response. Upon receiving the query's answer, the controller performs its pre-programmed command/control actions based on the response data and then polls the next wireless device.

The on-demand data model supports highly mobile nodes in the network where a gateway device is directed to enter a particular network, binds to that network and gathers data, then un-binds from that network. An example of an application using the on-demand data model is a tractor that connects to a trailer and binds the network between that tractor and trailer, which is accomplished by means of a gateway. When the tractor and trailer connect, association takes place and information is exchanged of information both of a data plate and vital sensor data. Now the tractor disconnects the trailer and connects to another trailer which then binds the network between the tractor and new trailer. With this model, one mobile gateway can bind to and un-bind from multiple networks, and multiple mobile gateways can bind to a given network. The on-demand data model is also used when binding takes place from a remote situation such as if a remote terminal was to bind with a trailer to evaluate the state of health of that trailer or if remote access via cellular or satellite interface initiates such a request.

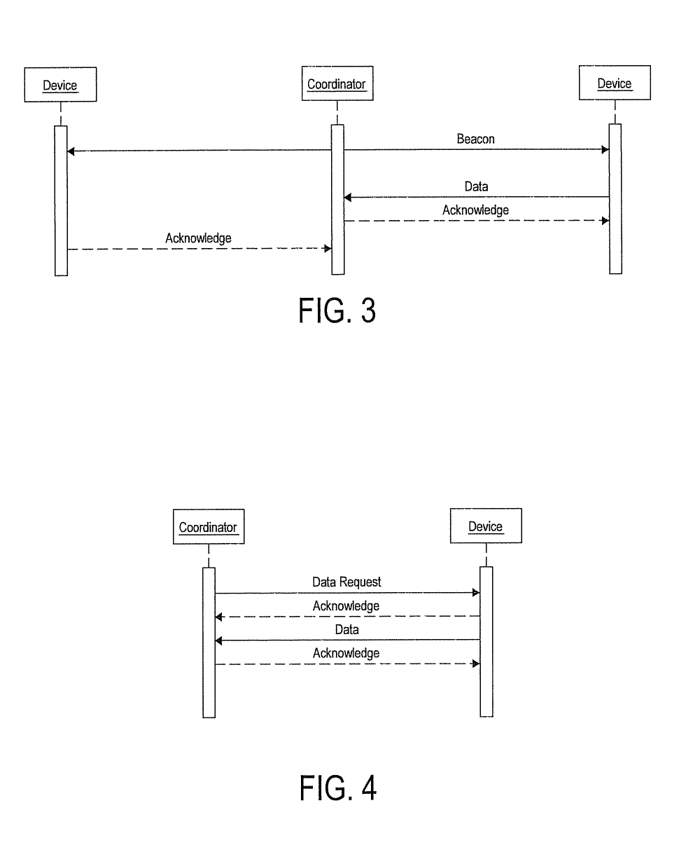

The vehicle network in accordance with an embodiment of the present invention employs either of two modes, beacon or non-beacon, to enable data traffic back and forth. Beacon mode is illustrated in FIG. 3 and is used when the coordinator runs on batteries and thus offers maximum power savings, whereas the non-beacon mode, which is illustrated in FIG. 4, finds favor when the coordinator is mains-powered.

In the beacon mode (see FIG. 3), a device effectively “watches out” for the coordinator's beacon that gets transmitted periodically, locks on and looks for messages addressed to it. If message transmission is complete, the coordinator dictates a schedule for the next beacon so that the device effectively “goes to sleep”. Preferably, the coordinator itself switches to sleep mode.

While using the beacon mode, all the devices in the mesh network effectively know when to communicate with each other. In this mode, necessarily, the timing circuits have to be quite accurate, or wake up sooner to be sure not to miss the beacon. This in turn means an increase in power consumption by the coordinator's receiver, entailing an optimal increase in costs.

The non-beacon mode (see FIG. 4) is provided in a system where devices are “asleep” nearly always, as in tire pressure monitors or door sensors. The devices wake up and confirm their continued presence in the network at random intervals. On detection of activity, the sensors “spring to attention,” as it were, and transmit to the ever-waiting coordinator's receiver (since it is mains-powered). However, there is the remotest of chances that a sensor finds the channel busy, in which case the acknowledgment allows for retry until success.

Referring to FIG. 2, the functions of the coordinator 22, which usually remains in the receptive mode, encompass network set-up, beacon transmission, node management, storage of node information and message routing between nodes. The network nodes, however, are meant to save energy (and so ‘sleep’ for long periods) and their functions include searching for network availability, data transfer, checking for pending data and querying for data from the coordinator.

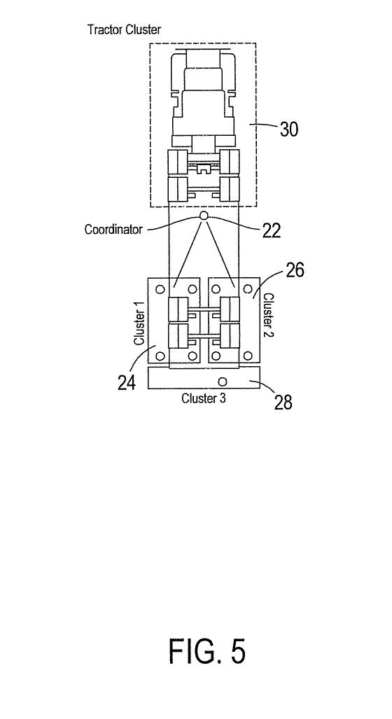

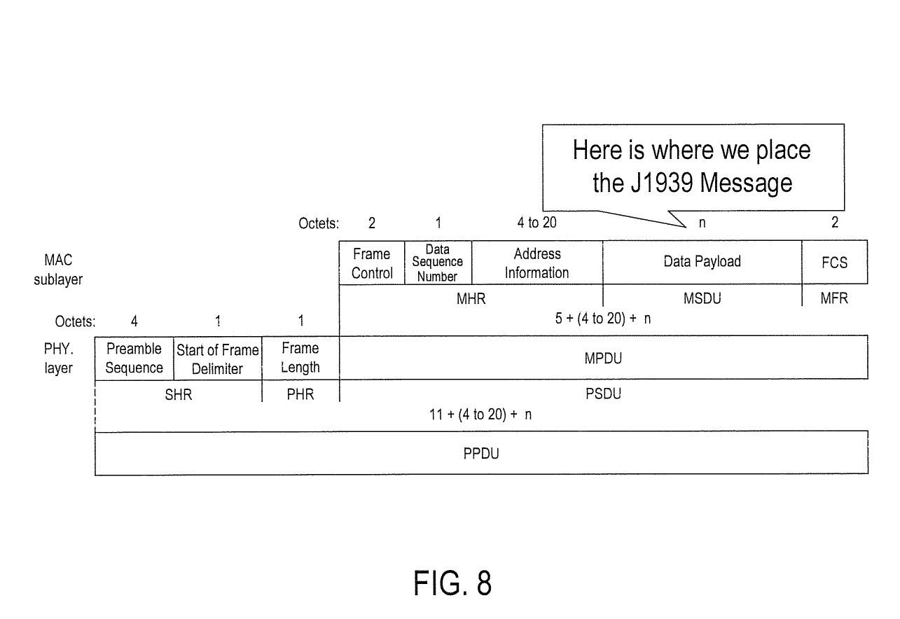

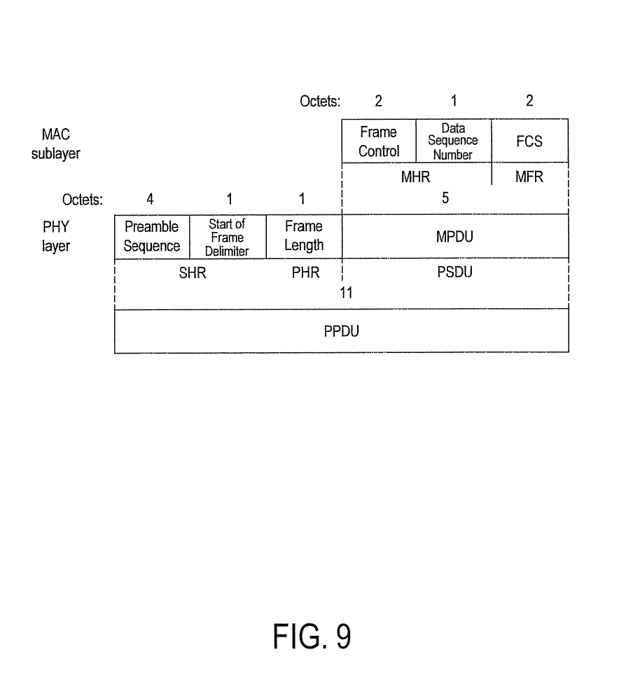

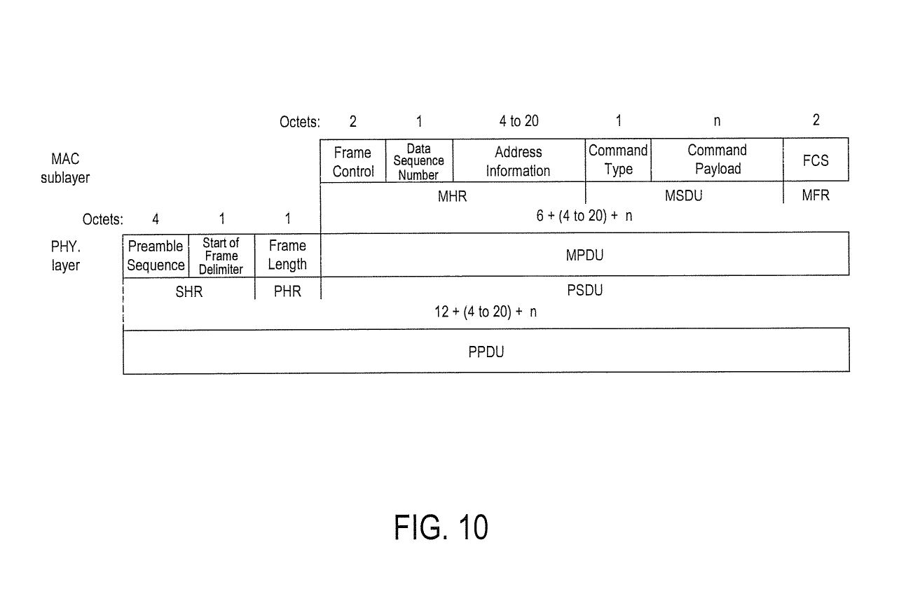

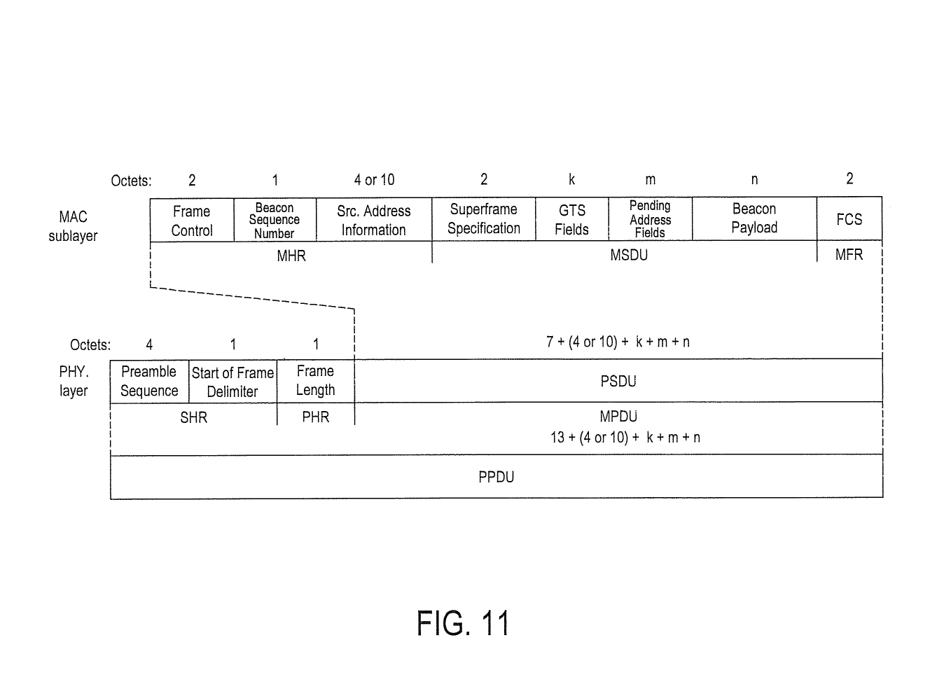

FIG. 5 illustrates an arrangement which is possible on a tractor-trailer. For the sake of simplicity without jeopardizing robustness, this particular architecture defines a quartet frame structure and a super-frame structure used optionally only by the coordinator. The four frame structures are: a beacon frame (see FIG. 11) for the transmission of beacons; a data frame (see FIG. 8) for all data transfers; an acknowledgement frame (see FIG. 9) for successful frame receipt confirmations; and a MAC command frame (see FIG. 10).

These frame structures and the coordinator's super-frame structure play critical roles in security of data and integrity in transmission. The coordinator lays down the format for the super-frame for sending beacons. The interval is determined a priori and the coordinator thus enables time slots of identical width between beacons so that channel access is contention-less. Within each time slot, access is contention-based. Nonetheless, the coordinator provides as many guaranteed time slots as needed for every beacon interval to ensure better quality.

With the vehicle network designed to enable two-way communications, not only will the driver be able to monitor and keep track of the status of his or her vehicle, but also feed it to a computer system for data analysis, prognostics, and other management features for the fleets.

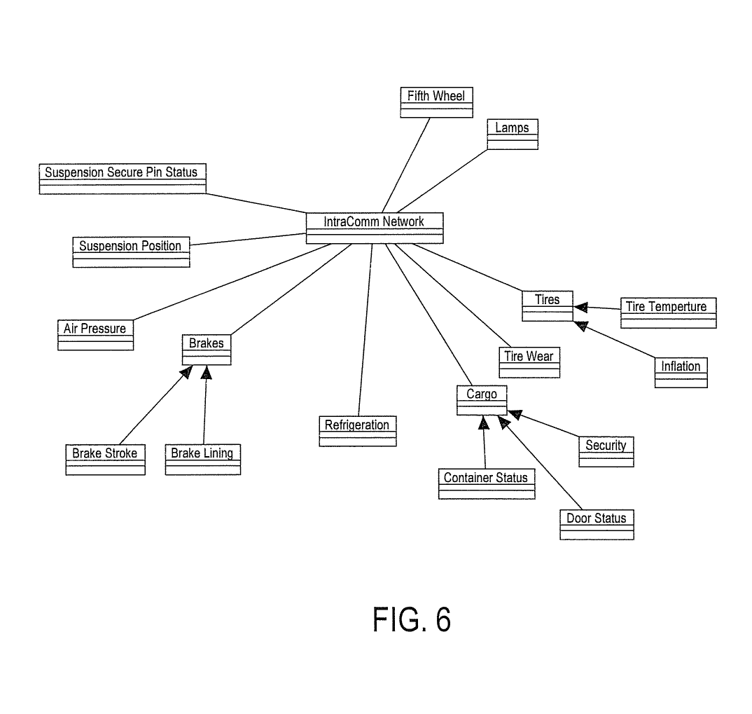

FIG. 6 illustrates some possible sensors, etc. that may be implemented within comprehensive tractor-trailer network.

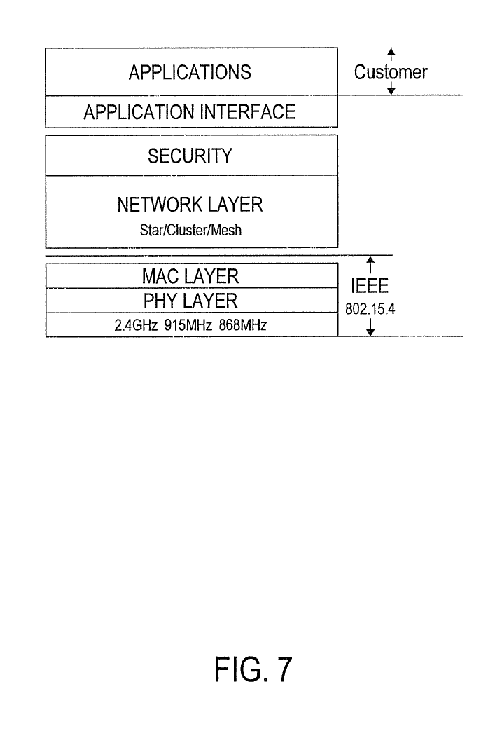

As discussed above, preferably IEEE 802.15.4 packet data protocol is implemented by the network. FIG. 7 illustrates protocol stack features, wherein the protocol utilizes a microcontroller, where a full protocol stack is <32 k and a simple node-only stack is ˜4 k. The coordinators may require extra RAM (for the node device database, a transaction table, and a pairing table).

With regard to the MAC in a IEEE 802.15.4 protocol, the MAC is configured to employ 64-bit IEEE and 16-bit short addresses. The ultimate network size can reach 2⁶⁴ nodes. However, using local addressing, simple networks of more than 65,000 (2¹⁶) nodes can be configured, with reduced address overhead.

The network may implement three different types of devices: a network controller, full function devices (FFD), and reduced function devices (RFD). Regardless, preferably the network has a simple frame structure, reliable delivery of data, has the ability to associate and disassociate, provides AES-128 security, provides CSMA-CA channel access, provides optional superframe structure with beacons, and provides a GTS mechanism.

Of the three device types, the network controller (identified with reference numeral 22 in FIGS. 2 and 5) is configured to maintain overall network knowledge, is the most sophisticated of the three types, and has the most memory and computing power. The full function devices (identified with reference numeral 32 in FIG. 2) are configured to carry full 802.15.4 functionality and all features specified by the standard, has additional memory and computing power which makes it ideal for a network router function, and could also be used in network edge devices (i.e., where the network interfaces the real world). The reduced function devices (identified with reference numeral 34 in FIG. 2) are configured to be carriers that have limited (as specified by the standard) functionality to control cost and complexity, and the general usage is in network edge devices. Regardless, each of these devices may be no more complicated that a transceiver, a simple 8-bit MCU and a lithium cell battery.

FIG. 8 illustrates the data frame format, which is one of two most basic and important structures in the IEEE 802.15.4 packet data protocol. The data frame format is configured to provide up to 104 byte data payload capacity, provides data sequence numbering to ensure that all packets are tracked, provide a robust frame structure that improves reception in difficult conditions, and provide a Frame Check Sequence (FCS) which ensures that packets are received without error.

FIG. 9 illustrates the acknowledgment frame format, which is the other most important structure for the IEEE 802.15.4 packet data protocol. The acknowledgment frame format is configured to provide active feedback from receiver to sender that the packet was received without error, and provide a short packet that takes advantage of standards-specified “quiet time” immediately after data packet transmission.

FIG. 10 illustrates the MAC command frame format, which is the mechanism for remote control/configuration of client nodes. The command frame format allows a centralized network manager to configure individual clients no matter how large the network.

FIG. 11 illustrates the beacon frame format. As described above, beacons add a new level of functionality to the network, wherein client devices can wake up only when a beacon is to be broadcast, listen for their address, and if not heard, return to sleep. Beacons are important for mesh and cluster tree networks to keep all of the nodes synchronized without requiring nodes to consume precious battery energy as a result of having to listen for long periods of time.

As discussed above, preferably a proprietary protocol is used which provides positive message acknowledgment, a secure transmission (encrypted data), and compression to achieve little degradation to loading.

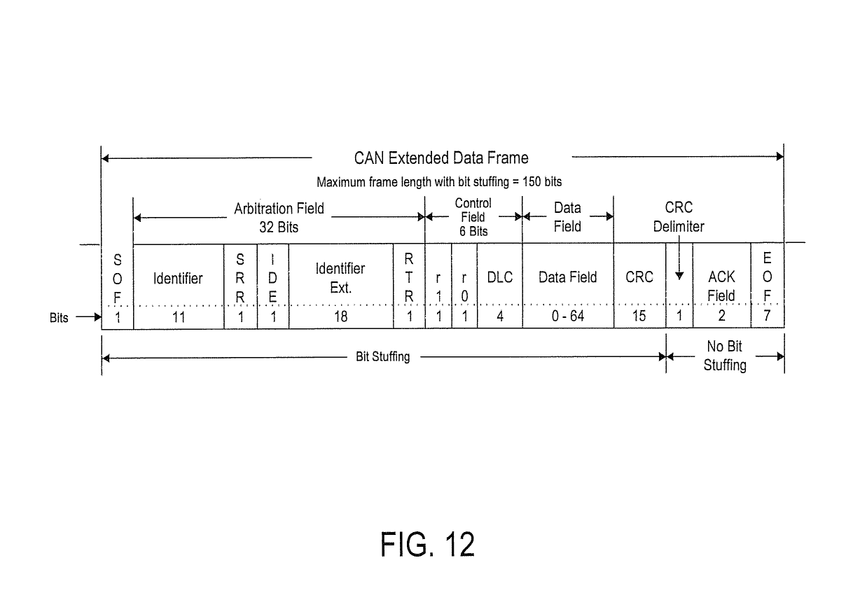

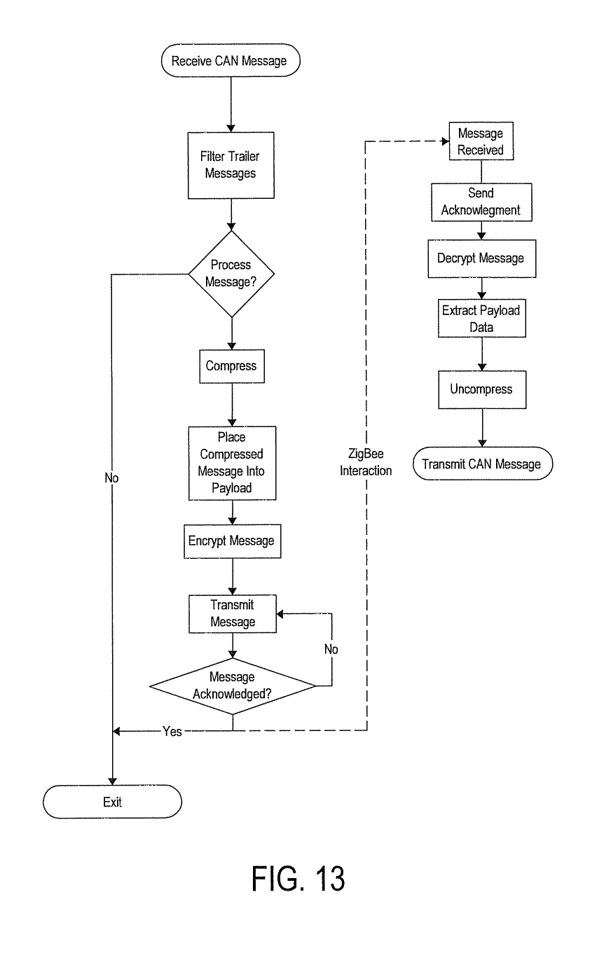

FIG. 12 illustrates CAN message content, and FIG. 13 illustrates a possible interaction sequence.

With regard to options for the MAC, preferably two channel access mechanisms are used. In a non-beacon network, there are standard ALOHA CSMA-CA communications, and positive acknowledgment for successfully received packets. On the other hand, in a beacon network, there is a superframe structure configured to provide dedicated bandwidth and low latency. Preferably, the network is set up by the coordinator to transmit beacons at predetermined intervals: 15 ms to 252 sec (15.38 ms*2n where 0≦n≦14); 16 equal-width time slots between beacons; channel access in each time slot is contention free. There may be three different security levels specified: none, access control lists, and symmetric key employing AES-128.

With regard to ISM band interference and coexistence, the potential exists in every ISM band, not just 2.4 GHz. While the IEEE 802.11 and 802.15.2 data packet protocol committees are presently addressing coexistence issues, the 802.15.4 protocol is very robust: there is clear channel checking before transmission; there is back off and retry if no acknowledgment is received; the duty cycle of a compliant device is usually extremely low; devices wait for an opening in an otherwise busy RF spectrum, and devices wait for acknowledgments to verify packet reception at the other end.

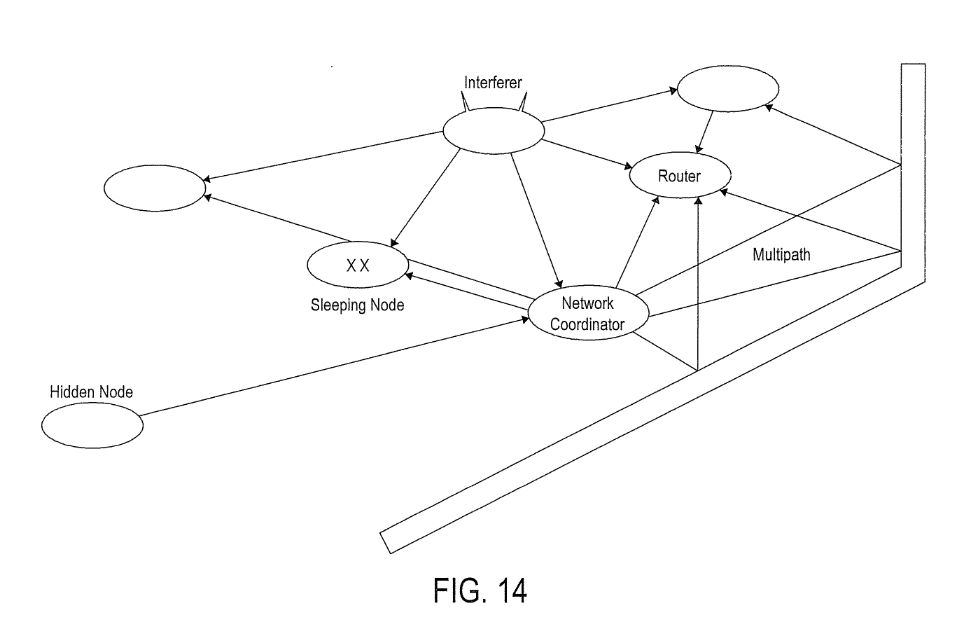

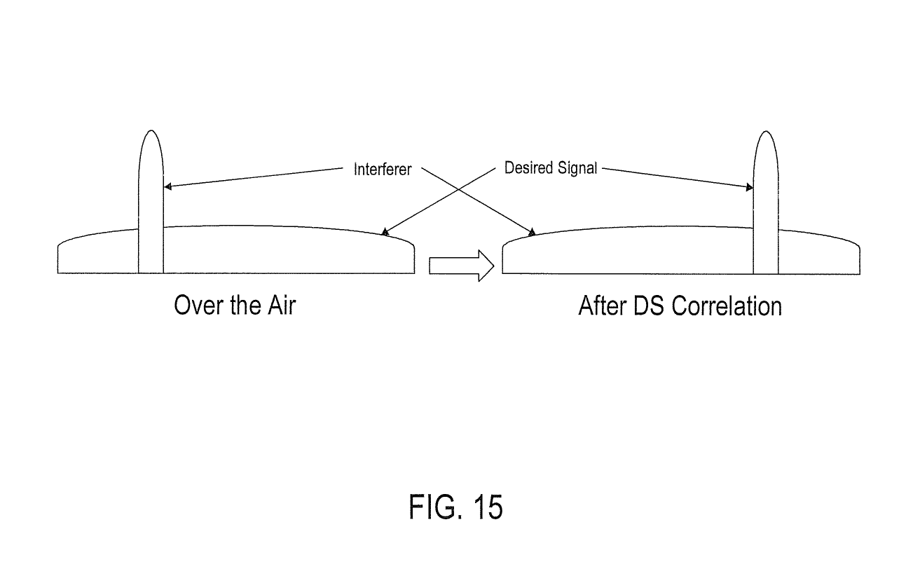

FIG. 14 provides a schematic view of the network, illustrating its reliability, and FIG. 15 illustrates the direct sequence aspect of the communication.

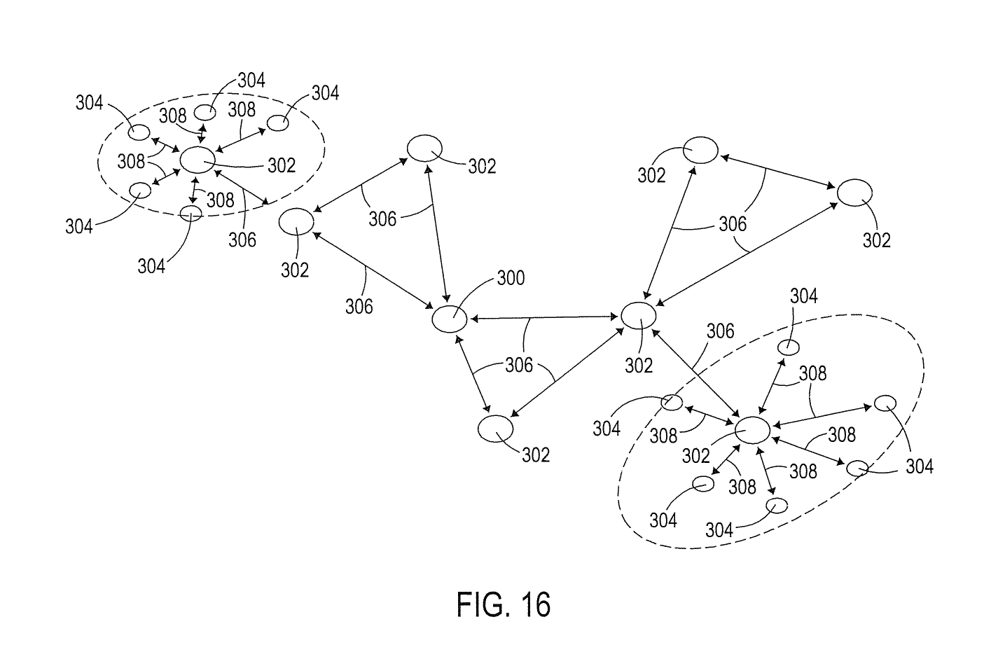

FIG. 16 illustrates a mesh network which is in accordance with an embodiment of the present invention. In FIG. 16, reference numeral 300 identifies a coordinator, reference numeral 302 identifies a router (FFD), reference numeral 304 identifies an end device (RFD or FFD), reference numeral 306 identifies a mesh link, and reference numeral 308 identifies a star link.

Preferably, the network is configured to provide direct sequence with frequency agility (DS/FA) rather than frequency hopping. DS/FA combines the best features of DS and FA without most of the problems caused by frequency hopping because frequency changes are not necessary most of the time, rather they are appropriate only on an exception basis.

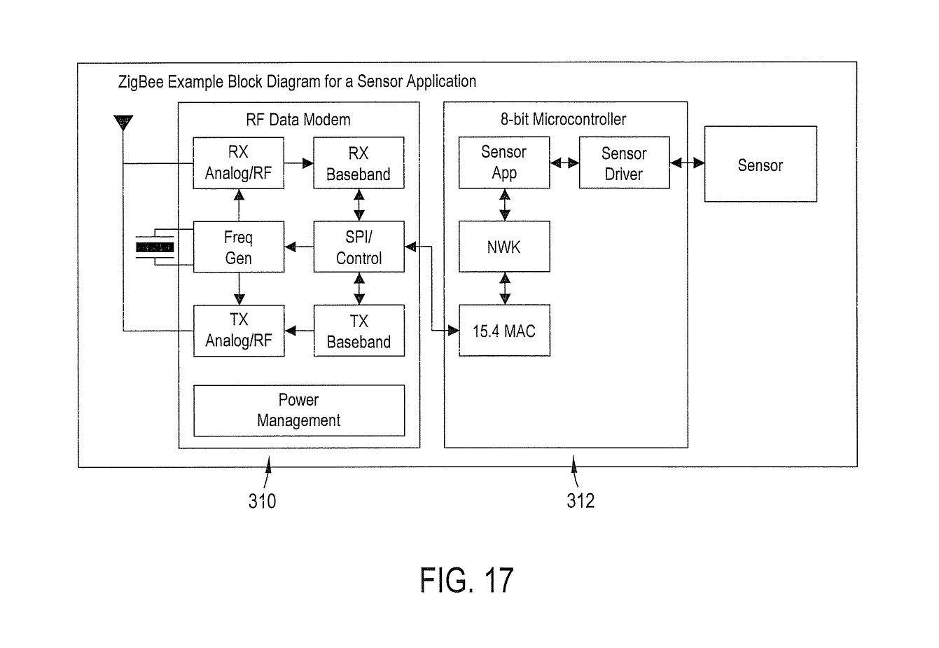

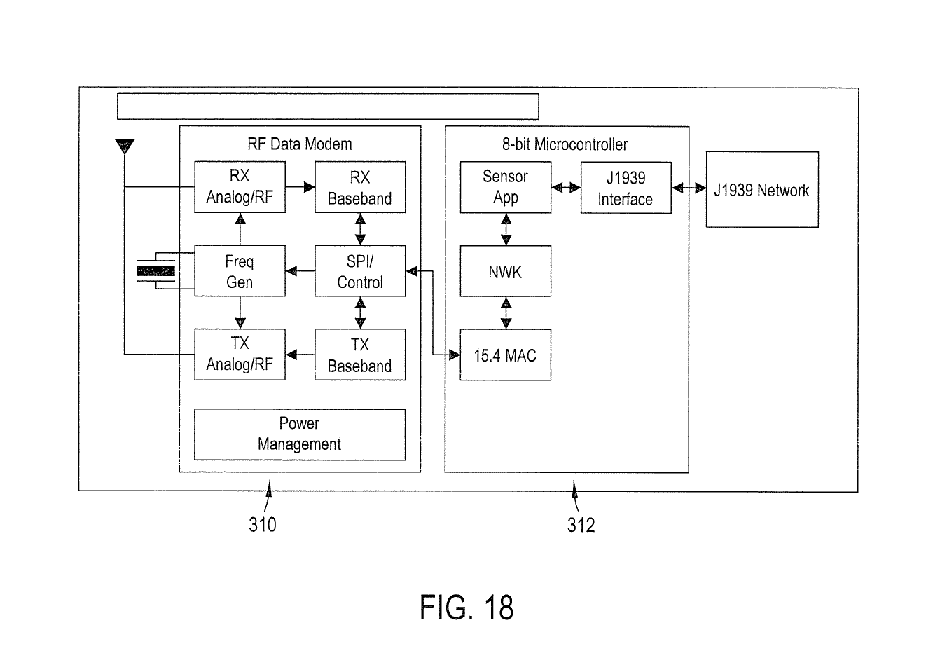

FIG. 17 illustrates an exemplary block diagram for a sensor application wherein reference numeral 310 identifies a Motorola RF packet radio and reference numeral 312 identifies a Motorola 8-bit MCU, while FIG. 18 illustrates an implementation using a J1939 interface.

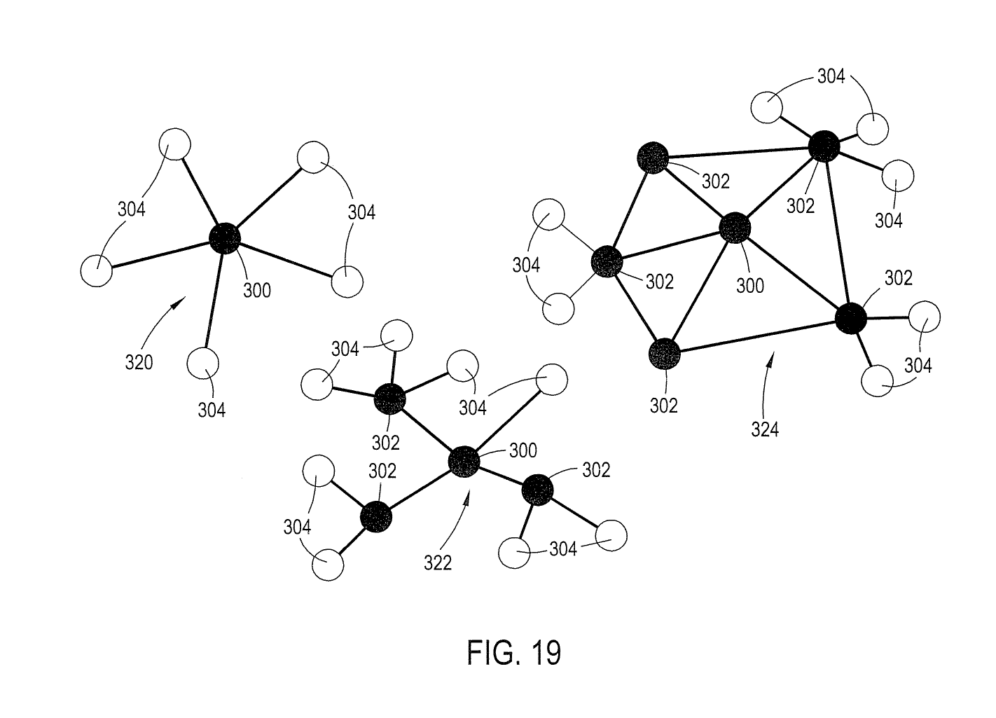

FIG. 19 illustrates three different topology models which can be used, wherein reference numeral 320 identifies a star configuration, reference numeral 322 identifies a cluster tree configuration, and reference numeral 324 identifies a mesh configuration. Within each configuration, reference numeral 300 identifies a coordinator, reference numeral 302 identifies a router (FFD) and reference numeral 304 identifies an end device (RFD or FFD).

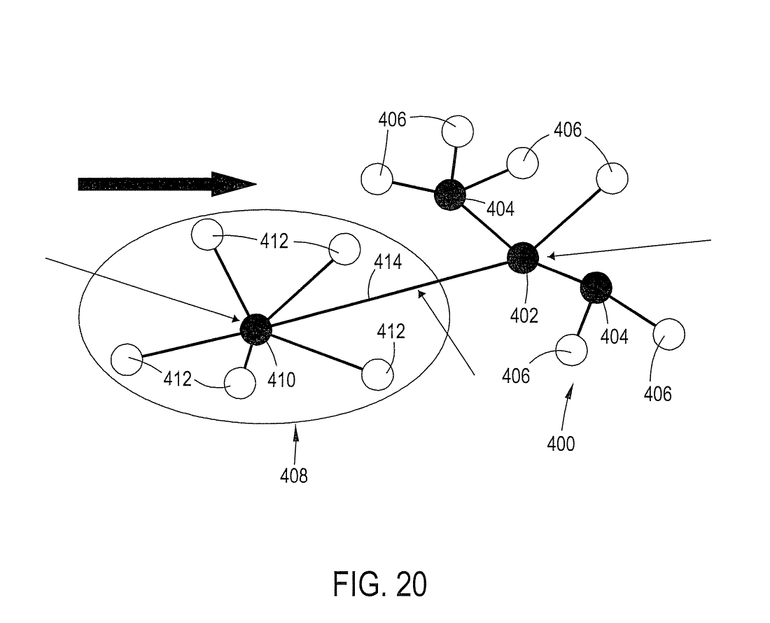

FIG. 20 illustrates the joining of one network 408 with another 400 (wherein line 414 indicates a new link which is established between the networks 400 and 408). Specifically, network 400 may comprise a tractor which includes a network coordinator 402 (i.e., a PAN coordinator), routers 404 and end devices 406. The joining network 408 may comprise a trailer which includes a network coordinator 410 and end devices 412. According to pre-existing network rules, the joining network's coordinator 410 is demoted to router, and passes along information about its network 408 (as required) to the coordinator 402 of the initial network 400. With regard to beacon information, this information is passed from coordinator 402 to router 410, and the router 410 is configured to awake to hear the network beacon. In another embodiment, each network 400, 408 may comprise a tractor-trailer combination which are being joined together.

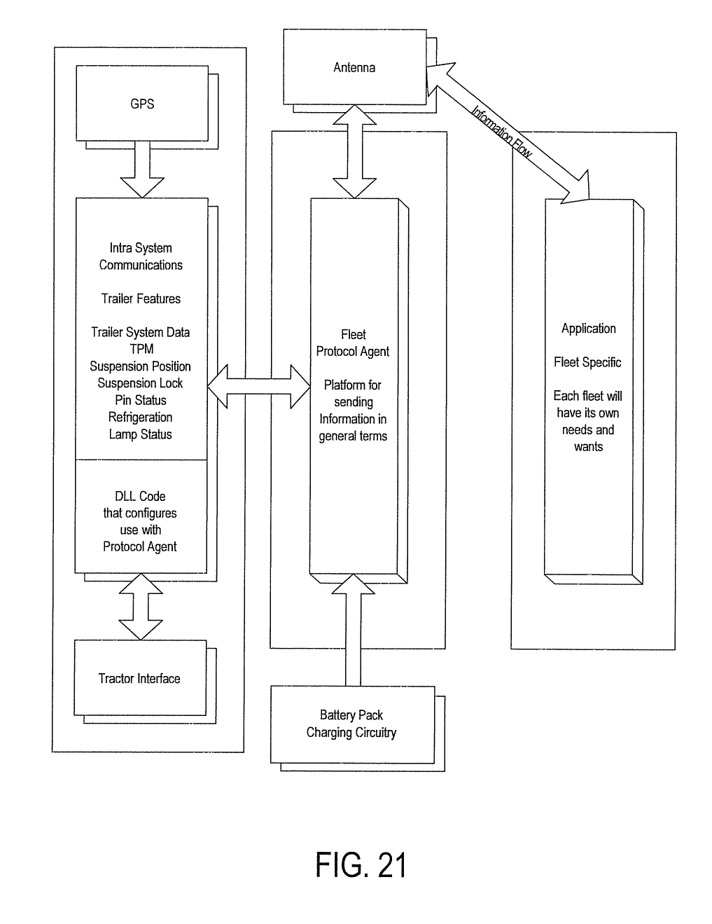

The network can also be implemented in a trailer tracking system, as illustrated in FIG. 21. The system is expected to reduce overtime expenses by improving labor productivity, by reducing/redirecting gate labor by providing fast lanes for dedicated carrier fleets, by reducing driver labor by enabling route consolidation, by reducing spoiled cargo and theft occurrences through sensor monitoring, by reducing/redirecting labor associated with yard and dock checks, by eliminating licensing, maintenance, leasing and administrative expenses associated with reduced equipment inventory, by reducing trailer demurrage/detention expense, by reducing line downtime occurrences, by reducing expenses associated with tractors pulling wrong trailers from the yard, and by reducing expenses by proper preventative maintenance. The system is also expected to reduce asset requirements by eliminating the percentage of tractor, trailer and/or dolly inventory, by eliminating the percentage of switch tractors, by eliminating the percentage of off site leased land for equipment storage, and by eliminating the need for yard and/or dock expansions. The system is expected to increase revenue by enabling higher production capabilities, and by transferring variable labor to direct labor positions. Finally, the system is expected to provide soft benefits which include improving customer satisfaction through on-time deliveries, improving yard safety by reducing congestion, equipment, and search times, and improving carrier negotiation position through better carrier performance data.

While embodiments of the invention are shown and described, it is envisioned that those skilled in the art may devise various modifications without departing from the spirit and scope of the foregoing description.

What is claimed is:

1. A wireless multi-node communication network comprising: a coordinator; and a plurality of vehicle nodes which are configured to communicate information back and forth with said coordinator.

2. A wireless multi-node communication network as recited in claim 1, wherein each vehicle node comprises a router which is configured to communicate information back and forth with said coordinator.

3. A wireless multi-node communication network as recited in claim 1, wherein each vehicle node comprises a router which is configured to communicate information back and forth with said coordinator, and a plurality of clusters, wherein each cluster is configured to communicate information to said router.

4. A wireless multi-node communication network as recited in claim 1, wherein each vehicle node comprises a router which is configured to communicate information back and forth with said coordinator, and a plurality of clusters, wherein each cluster comprises at least one sensor, and each cluster is configured to communicate information to said router.

5. A wireless multi-node communication network as recited in claim 4, wherein said at least one sensor is configured to periodically awaken.

6. A wireless multi-node communication network as recited in claim 5, wherein said at least one sensor is configured to check parameters and communicate, if necessary, information to said router or coordinator.

7. A wireless multi-node communication network as recited in claim 6, wherein said at least one sensor is configured to go into sleep mode.

8. A wireless multi-node communication network as recited in claim 4, wherein said at least one sensor is configurable to actuate in accordance with at least one of the following data collection models: periodic sampling, event-driven, and on-demand.

9. A wireless multi-node communication network as recited in claim 4, wherein said at least one sensor is configurable to communicate to said router or coordinator in accordance with at least one of the following models: periodic, event-driven, store and forward, polling and on-demand.

10. A wireless multi-node communication network as recited in claim 4, wherein said at least one sensor is configured to activate, compare data to preset, and decide whether to send information to the router or coordinator, and deactivate.

11. A wireless multi-node communication network as recited in claim 4, wherein said at least one sensor is configured to sense an event, send information to the router or coordinator, and then deactivate.

12. A wireless multi-node communication network as recited in claim 4, wherein said at least one sensor is configurable to store information and periodically, or on demand, send information to the router or coordinator.

13. A wireless multi-node communication network as recited in claim 3, wherein the at least one cluster is configured to communicate with the router or coordinator using a standard protocol such as IEEE 802.15.4 packet data protocol.

14. A wireless multi-node communication network as recited in claim 13, wherein communication is along a standard band such as the 2.4 GHz band.

15. A wireless multi-node communication network as recited in claim 4, wherein the at least one sensor is configured to listen for a beacon from said coordinator and upon receiving said beacon, activate, collect and send data, and deactivate.

16. A wireless multi-node communication network as recited in claim 4, wherein the at least one sensor comprises at least one of a pressure sensor, temperature sensor, and voltage sensor, for example.

17. A wireless multi-node communication network as recited in claim 1, further comprising multiple sensors which form clusters to communicate information to the coordinator to extend battery life.

18. A wireless multi-node communication network as recited in claim 4, wherein the at least one sensor is configured to retry communication with the router or coordinator if an acknowledge is not received from said router or coordinator.

19. A wireless multi-node communication network as recited in claim 1, wherein all of the nodes are configured to communicate and receive communication.

20. A wireless multi-node communication network as recited in claim 1, wherein the wireless multi-node communication network is configured such that the formation of a new vehicle network is initiated through a network layer primitive that is restricted to the coordinator.

21. A wireless multi-node communication network as recited in claim 20, wherein the wireless multi-node communication network is configured such that at the beginning of network formation, the coordinator performs an energy detection scan over a specified set of RF channels.

22. A wireless multi-node communication network as recited in claim 21, wherein the wireless multi-node communication network is configured such that after said channel scan, the channels are ordered according to increasing RF energy and channels whose energy levels are deemed too high are discarded.

23. A wireless multi-node communication network as recited in claim 21, wherein the coordinator is configured to perform an active scan on each of the selected RF channels to search for other devices associated with the vehicle.

24. A wireless multi-node communication network as recited in claim 23, wherein based on the results of the scan, the coordinator chooses the best RF channel for a new network, giving preference to any channel on which no existing networks were found.

25. A wireless multi-node communication network as recited in claim 20, wherein the coordinator is configured to choose the logical network identifier that will be applied to all devices that join the network.

26. A wireless multi-node communication network as recited in claim 20, wherein the coordinator is configured to begin to allow devices to join the network.

27. A wireless multi-node communication network as recited in claim 26, wherein the coordinator is configured to permit new devices to join the network through an association process.

28. A wireless multi-node communication network as recited in claim 20, wherein the wireless multi-node communication network is configured such that devices that lose contact with their coordinator can rejoin a network through an orphaning process.

29. A wireless multi-node communication network as recited in claim 20, wherein the wireless multi-node communication network is configured to provide that a vehicle network layer defines mechanisms for joining and leaving a network, routing frames to their proper destinations, and applying security to these frames.

30. A wireless multi-node communication network as recited in claim 20, wherein the wireless multi-node communication network is configured to provide that network layer primitive cover the discovery and maintenance of routes between devices or sensors, the discovery of neighbor devices or sensors that can be reached directly, and the storage of network state information.
